(19) United States
(12) Patent Application Publication
(10) Pub. No.: US 2007/0165704 A1
(43) Pub. Date: Jul. 19, 2007

(54) Method for auxiliary pilot cancellation in wireless network reverse link

(75) Inventors: Yang Yang, Parsippany, NJ (US); Henry Hui Ye, Ledgewood, NJ (US)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/336,147

(22) Filed: Jan. 19, 2006

(51) Int. Cl. H04B 1/00

(52) U.S. Cl. 375/148

(57) ABSTRACT

In carrying out a method for auxiliary pilot cancellation in a wireless network reverse link, a base station receives signals from various wireless units over the reverse link. Some of the wireless units may transmit auxiliary pilot signals when transmitting high-speed packet data. For each active wireless unit, the base station monitors the received signals for the presence of auxiliary pilot signals. When present, the auxiliary pilot signals are regenerated, combined, and removed from the composite received signals, forming an interference-free output signal. The output signal is routed to an array of decoding units (one for each active user), for decoding data traffic. The auxiliary pilot signals may be routed to the decoding units for use in channel estimation calculations.

### FIELD OF THE INVENTION

The present invention relates to communications and, more particularly, to wireless communications systems.

### BACKGROUND OF THE INVENTION

In certain wireless, radio frequency (“RF”) communications systems, e.g., those using the CDMA (code division multiple access) spread-spectrum multiplexing scheme, data and other signals are transmitted from one or more fixed base stations to one or more wireless units across a first frequency bandwidth known as the forward link. Transmissions from the wireless units to the base stations are across a second frequency bandwidth known as the reverse link. The forward and reverse links may each comprise a number of physical or logical traffic channels and signaling/control channels, the former primarily for carrying voice data, and the latter primarily for carrying the control, synchronization, and other signals required for implementing CDMA or other communications.

For coherent wireless communications such as used in CDMA, pilot signal-assisted channel estimation schemes may be used. The forward link pilot channel/signal is an un-modulated, direct-sequence spread spectrum signal transmitted by the base stations. Similar signals may be transmitted across the reverse link (from wireless units to base stations) in certain CDMA-based systems. Pilot signal-assisted methods allow a wireless unit to acquire the timing of the forward link, or a base station to acquire the timing of the reverse link. They also provide a phase reference for coherent demodulation, as well as a means for signal strength comparisons between base stations for use in call handoff.

High speed wireless data systems such as 1x-EVDO Rev. A, UMTS/HSDPA/E-DCH, and EVDV Rev. D have significantly increased the reverse link channel data rate range in order to provide high data throughput for wireless units in good RF conditions. (1x-EVDO, for example, is an implementation of the CDMA2000® “3-G”/third generation mobile telecommunications protocol/specification configured for the high-speed wireless transmission of both voice and non-voice data.) 1x-EVDO Rev. A and EVDV Rev. D both have reverse link peak data transmission rates of 1.8 Mbps, while the reverse link peak data transmission rate in UMTS/HSDPA/E-DCH reaches 5.76 Mbps. To assist with channel estimation and packet decoding for high-rate data packets, reverse link auxiliary pilot signals (sometimes referred to as secondary pilots) may be used in addition to the primary pilot channel when the packet data rate exceeds a certain threshold, e.g., as specified in the 1x-EVDO and EVDV standards. For facilitating reliable channel estimation during traffic decoding processes, auxiliary pilots are typically set at a much higher power level than the primary pilot channel(s). Due to their high power level, however, auxiliary pilots become a non-trivial interference source for other active wireless units in the system whenever the auxiliary pilot signals are present.

### SUMMARY OF THE INVENTION

An embodiment of the present invention relates to a method for communicating over a wireless network with a wireless unit, which may include, for example, mobile phones, wireless PDA's, wireless devices with high-speed data transfer capabilities, such as those compliant with “3-G” or “4-G” standards, “WiFi”-equipped computer terminals, and the like. In carrying out the method, signals received from the wireless unit over a network reverse link are monitored for the presence of an auxiliary pilot signal. During times when the auxiliary pilot signal is present, the auxiliary pilot signal is removed from the other received signals. The resultant output signal(s) (“output” is an arbitrary designation) may be further processed for, e.g., decoding data in a received traffic channel/signal.

In another embodiment, an auxiliary pilot signal is removed from a composite signal received over the reverse link from a wireless unit. (By “composite” signal, it is meant a plurality of signals in the reverse link channel/bandwidth, which may include separate signals and/or interleaved, multiplexed, and/or encoded signals, depending on the communications protocol in place on the network.) Prior to its removal from the composite signal, the auxiliary pilot signal is regenerated as a separate signal. (By “regenerate,” it is meant separating, deriving, re-forming, or the like.) The auxiliary pilot signal is used to determine one or more channel estimations for the wireless unit. Such estimations may include channel/signal timing of the reverse link, phase references, signal strength comparisons, and the like. The estimations may be used as part of a process for decoding data in a traffic channel portion of the composite signal. For example, both the clean output signal (e.g., the received composite signal with the auxiliary pilot signal removed therefrom) and the auxiliary pilot signal may be fed into a decoding circuit. The auxiliary pilot signal may be provided by way of the composite signal or as a separate signal as regenerated.

In another embodiment, the reverse link channel is monitored for the presence of auxiliary pilot signals. Extant auxiliary pilot signals are regenerated from the signals received over the reverse link. If more than one auxiliary pilot signal is present, they may be combined into an aggregate signal. Subsequently, the aggregate signal is removed from the received signals for removing auxiliary pilot channel interference. The resulting output signal is then further processed, e.g., for decoding data in a traffic channel.

### BRIEF DESCRIPTION OF THE DRAWINGS

The present invention will be better understood from reading the following description of non-limiting embodiments, with reference to the attached drawings, wherein below:

FIG. 1 is a simplified schematic diagram of a wireless communication network;

FIG. 2 is a schematic diagram of a base station channel reception module according to an embodiment of the present invention;

FIG. 3 is a flowchart illustrating a method of auxiliary pilot interference cancellation according to an embodiment of the present invention; and

FIGS. 4 and 5 are schematic diagrams of base station channel reception modules according to additional embodiments of the present invention.

### DETAILED DESCRIPTION

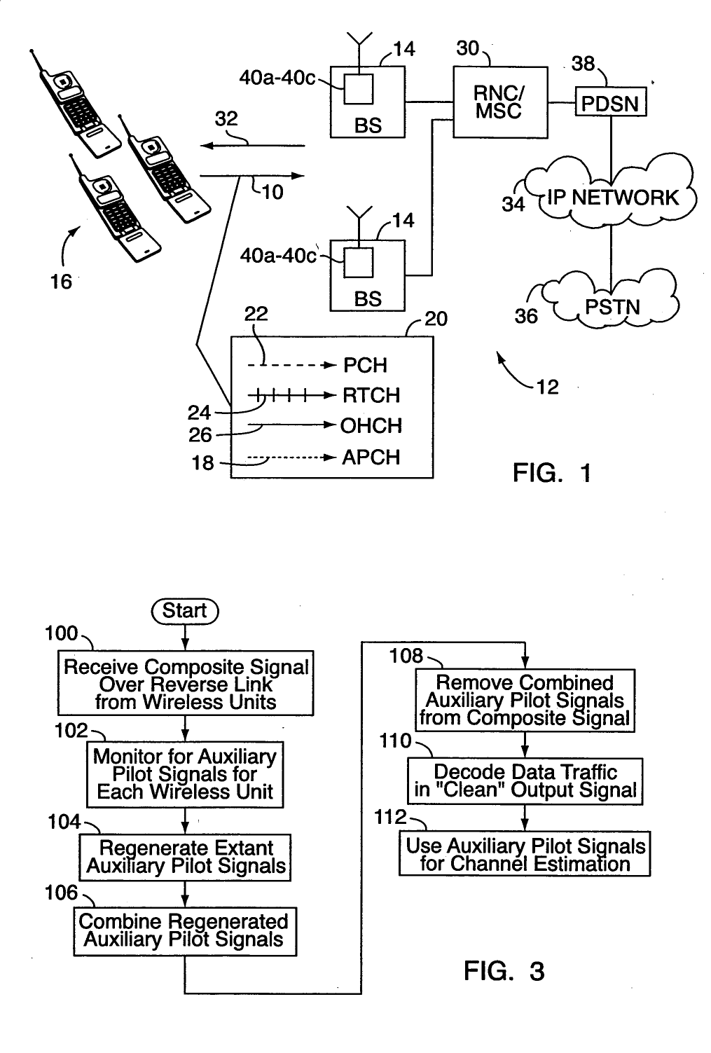

With reference to FIGS. 1-3, an embodiment of the present invention relates to a method for canceling auxiliary pilot signal interference over the reverse link 10 of a wireless communications network 12. The wireless network 12 will typically include a number of base stations (“BS”) 14 in communication with a number of wireless units 16. When transmitting high-speed packet or other data, one or more of the wireless units 16 may transmit an auxiliary pilot channel signal (“APCH”) 18 for use by the base stations 14 in channel estimation procedures for assisting in decoding the high-speed data. The auxiliary pilot signals 18 are received at the base stations 14 as part of a reverse link “composite” signal 20, which may also include primary pilot signals over a primary pilot channel (“PCH”) 22, data/traffic signals over a reverse link traffic channel (“RTCH”) 24, and overhead signals over an overhead channel (“OHCH”) 26. (In particular, each wireless unit 16 will typically transmit over the reverse link 10 a primary pilot signal, traffic signals, overhead signals, and an auxiliary pilot signal when transmitting high-speed data over the RTCH 24.) The base stations 14 monitor the reverse link 10 for detecting the presence of auxiliary pilot signals 18, which are subsequently combined and removed from the received composite signal 20. The resultant “output” signal 28, free of interference from the auxiliary pilot signals 18, may then be further processed, such as decoding the data in the traffic channels 24. The auxiliary pilot signals 18 may still be used for channel estimation procedures.

The method of the present invention may be implemented on various types of wireless networks. For example, the network 12 may be a CDMA-based 1x-EVDO communications network having a radio network controller (“RNC”) and/or mobile switching center (“MSC”) 30 and one or more fixed base stations 14. The base stations 14 are provided with various transceivers and antennae for radio communications with the wireless units 16, while the radio network controller 30 directs data transfer to and from the base stations 14 for transmission to the wireless units 16. The wireless units 16 may include, for example, mobile phones, wireless PDA's, wireless devices with high-speed data transfer capabilities, such as those compliant with “3-G” or “4-G” standards, “WiFi”-equipped computer terminals, and the like. For conducting wireless communications between the base stations 14 and the wireless units 16, the network 12 may utilize a CDMA (code division multiple access) spread-spectrum multiplexing scheme. In CDMA-based networks, transmissions from wireless units to base stations are across a single frequency bandwidth known as the reverse link 10, e.g., a 1.25 MHz bandwidth centered at a first designated frequency. Generally, each wireless unit 16 is allocated the entire bandwidth all the time, with the signals from individual access terminals being differentiated from one another using an encoding scheme. Transmissions from base stations to wireless units are across a similar frequency bandwidth (e.g., 1.25 MHz centered at a second designated frequency) known as the forward link 32. The network 12 may be geographically divided into contiguous cells, each serviced by a base station, and/or into sectors, which are portions of a cell typically serviced by different antennae/receivers supported on a single base station.

The network 12 may also include a core packet data network 34 for the long distance wire-line transmission of packet data, and/or for interconnecting various components or portions of the network 12. For example, the core packet data network 34 may be used to connect the radio network controller 30 to a network service or administration module, or to one or more external networks such as a public switched telephone network (“PSTN”) 36. As should be appreciated, the core packet data network 34 may be a dedicated network, a general-purpose network (such as the Internet), or a combination of the two. Typically, the radio network controller 30 will be connected to the packet data network 34 by way of a packet data serving node (“PDSN”) 38 or the like. For high-speed data transmission across the packet data network 34 (e.g., for facilitating web browsing, real time file transfer, or downloading large data files), the network 12 may use the Internet Protocol (“IP”), where data is broken into a plurality of addressed data packets. Additionally, VoIP (voice over IP) may be used for voice-data transmission. (With VoIP, analog audio signals are captured, digitized, and broken into packets like non-voice data.) Both voice and non-voice data packets are transmitted and routed over the wireless network 12, where they are received and reassembled by the wireless units 16 to which the data packets are addressed.

As noted above, in ongoing communications over the network 12, the wireless units 16 transmit various signals over the reverse link 10. These may include signals over a primary pilot channel 22, a reverse traffic channel 24, and one or more overhead channels 26. In addition, the wireless units 16 may occasionally transmit packet or other data at an increased or “burst” rate. For example, in uploading large files (such as graphics files, large forms, or e-mail messages with attachments), the wireless units 16 may request a data burst rate for more quickly transmitting the large files. When transmitting data at an increased rate, the wireless units 16 may also transmit the high-power auxiliary pilot signals 18 over the reverse link 10. The auxiliary pilot signals 18 are used by the base stations for channel estimation and packet decoding purposes.

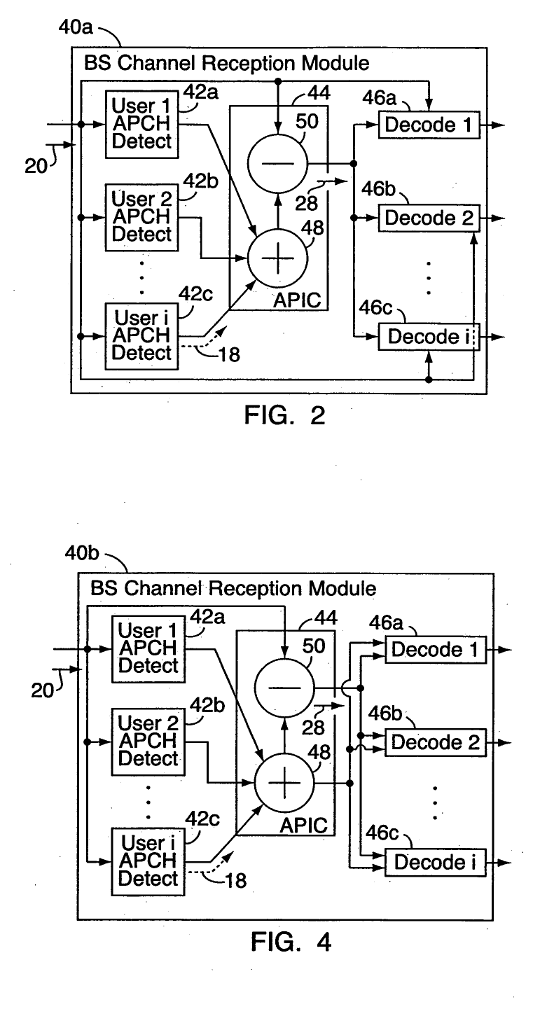

At Step 100 in FIG. 3, for each base station 14, the base station 14 receives the composite signal 20 over the reverse link 10 from active wireless units 16. As noted, the composite signal 20 may include the primary pilot signals 22, reverse link traffic signals 24, overhead signals 26, and possibly one or more auxiliary pilot signals 28, from all the active wireless units 16 in communication with the base station 14 in combination. For receiving and processing signals over the reverse link 10 generally, the base station 14 will typically include a channel reception module 40a-40c or the like as part of a base station controller. (The base station controller is configured for controlling the reception and transmission of signals between the wireless units 16 and radio network controller 30.) A portion of a first embodiment of the channel reception module 40a is shown in FIG. 2, as configured for implementing the method of auxiliary pilot cancellation. In particular, the channel reception module 40a includes a number of auxiliary pilot signal detection and regeneration circuits 42a-42c, an auxiliary pilot interference cancellation circuit/module 44 (“APIC”), and a plurality of data traffic decoding modules/circuits 46a-46c. Typically, the number of detection circuits 42a-42c and decoding circuits 46a-46c will depend on the capacity of the base station 14. In other words, if the base station is configured for handing communications with “i” number of active wireless units, the channel reception module 40 will have “i” detection and decoding circuits. These circuits are reassigned to different wireless units as wireless units come on and off line.

Once received, the composite signal 20 is routed to the inputs of each of the auxiliary pilot signal detection and regeneration circuits 42a-42c. As should be appreciated, the composite signal as received at the base station antenna will typically first be subjected to one or more “pre-processing” steps for RF reception, depending on the particular configuration of the base station, for putting the signals into a condition for digital processing. For example, the base station channel reception module may further include an antenna gain stage (e.g., reception bandpass filter and low noise amplifier) and an RF receiver (e.g., mixer, local oscillator circuit, and receiver intermediate frequency stages)(not shown). At Step 102, the detection and regeneration circuits 42a-42c monitor the composite signal 20 for detecting the presence of auxiliary pilot signals, for each active wireless unit 16 respectively. In other words, a first detection circuit 42a, for example, temporarily assigned to a first wireless unit, monitors the composite signal 20 for an auxiliary pilot signal transmitted from that wireless unit. This may involve using a standard “energy hypothesis” process, by which the power level of the received signal is compared with the expected or projected power level of a signal both with and without the auxiliary pilot signals, based on the communication protocol(s) in place on the network 12. At Step 104, for each detection circuit 42a-42c, if an auxiliary pilot signal is detected, the auxiliary pilot signal is regenerated from the composite signal 20. This may include re-forming, filtering, isolating, or otherwise separating the auxiliary pilot signal from the composite signal, through a standard digital signal processing process or the like.

The outputs of the detection and regeneration circuits 42a-42c are fed into the APIC module/circuit 44. The APIC module 44 includes a signal summation or aggregation circuit/module 48 and a signal subtraction or removal circuit/module 50. The signal aggregation module 48 has one or more inputs connected to the outputs of the detection and regeneration circuits 42a-42c. The output of the signal aggregation module 48 is fed into one of the inputs of the signal removal module 50. The signal removal module has an additional input, into which is directed the composite signal 20. In operation, at Step 106 the regenerated auxiliary pilot signals 20 are combined together by the aggregation module 48 into an aggregate signal, which may include synchronizing the regenerated pilot signals in terms of time, phase, or the like. At Step 108, the aggregate signal (e.g., the combined auxiliary pilot signals) is removed from the composite signal 20 by the signal removal module 50. Again, signal synchronization may be required. This results in the “clean” output signal 28, which comprises the originally received composite signal 20 but with the auxiliary pilot signals (and corresponding interference) removed therefrom. As should be appreciated, although the aggregation module and signal removal modules are referred to as modules or circuits, these are meant to represent functional blocks which may be implemented in hardware as dedicated circuits, but which also may be implemented as functions in an appropriately programmed/controlled digital signal processor, using standard digital signal processing methods as known in the art.

The output signal 28 is routed to the data traffic decoding modules 46a-46c. At Step 110, the traffic decoding modules 46a-46c decode the data signals 24 associated with the wireless units 16 to which they are respectively temporarily assigned. Because the output signal 28 is free from auxiliary pilot signal interference, traffic decoding performance is improved. This also results in improved packet data reception for all of the wireless units 16, and in improved aggregate sector data throughput in general. After decoding, the data is directed “upstream” for further standard processing and for transmission over the wireline end of the network 12.

As indicated in FIG. 2, the composite signal 20 may also be routed to the data traffic decoding modules 46a-46c. At Step 112, the decoding modules 46a-46c use the auxiliary pilot signals in the composite signal 20 (as applicable to their respectively assigned wireless units), when present, to determine one or more channel estimations for improving data decoding of the interference free output signal 28. As noted above, such estimations may include channel/signal timing of the reverse link, phase references, signal strength comparisons, and the like.

If no auxiliary pilot signals are present in the reverse link 10, the composite signal 20 is, in effect, simply routed to the inputs of the traffic decoding modules 46a-46c. In such a case, the composite signal 20 is still routed through the APIC module 44, but remains unmodified since there is no aggregate signal present at the output of the aggregation module 48 to remove.

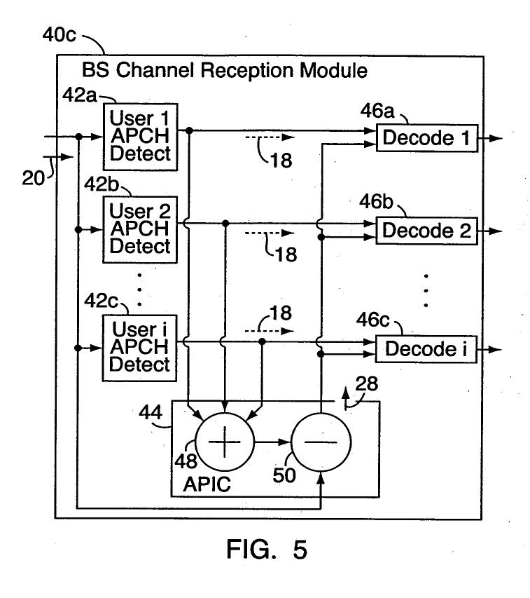

FIGS. 4 and 5 show alternative embodiments 40b, 40c, respectively, of the channel reception module. Both operate generally the same as described above with reference to the module 40a in FIG. 2. In the channel reception module 40b in FIG. 4, instead of routing the composite signal 20 to the traffic decoding modules 46a-46c for possible use in channel estimation procedures/calculations, the aggregate auxiliary pilot signal output from the aggregation module 48 is routed to the decoding modules 46a-46c. In the channel reception module 40c in FIG. 5, the regenerated auxiliary pilot signals output from the detection and regeneration modules 42a-42c are routed directly to respective traffic decoding modules 46a-46c. (In such a case, each pair of interconnected detection/regeneration module and traffic decoding module would have to be assigned to the same wireless unit in ongoing operations.) In all three of the channel reception modules 40a-40c, the auxiliary pilot signals may be somehow supplied to the traffic decoding modules 46a-46c for possible channel estimation, in addition to the interference-free composite/output signal 28.

Since certain changes may be made in the above-described method of auxiliary pilot signal interference cancellation in a wireless network reverse link, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method for communicating with at least one wireless unit over a network, said method comprising the steps of:
monitoring a plurality of signals received from the at least one wireless unit for the presence of at least one auxiliary pilot signal; and
removing the at least one auxiliary pilot signal from the plurality of received signals to form at least one output signal.

2. The method of claim 1 further comprising:
decoding data from the at least one output signal.

3. The method of claim 2 further comprising:
determining at least one channel estimation from the at least one auxiliary pilot signal, wherein the data in the at least one output signal is decoded at least in part based on the at least one channel estimation.

4. The method of claim 3 wherein the at least one channel estimation is determined from the at least one auxiliary pilot signal in the plurality of received signals.

5. The method of claim 3 further comprising:
prior to the step of removing the at least one auxiliary signal from the plurality of received signals, regenerating the at least one auxiliary pilot signal from the plurality of received signals.

6. The method of claim 5 wherein the at least one channel estimation is determined from the auxiliary pilot signal as regenerated.

7. A method for communicating with at least one wireless unit over a network, said method comprising the steps of:
regenerating at least one auxiliary pilot signal from a composite signal received from the at least one wireless unit, said composite signal comprising the auxiliary pilot signal and at least one traffic signal; and
removing the at least one regenerated auxiliary pilot signal from the composite signal.

8. The method of claim 7 further comprising:
monitoring the received composite signal for detection of the auxiliary pilot signal.

9. The method of claim 7 further comprising:
subsequent to the step of removing the regenerated auxiliary pilot signal from the composite signal, decoding data from the at least one traffic signal in the composite signal.

10. The method of claim 9 further comprising:
determining at least one channel estimation from the auxiliary pilot signal, wherein the data in the at least one traffic signal is decoded at least in part based on the at least one channel estimation.

11. The method of claim 10 wherein the at least one channel estimation is determined from the auxiliary pilot signal in the received composite signal.

12. The method of claim 10 wherein the at least one channel estimation is determined from the auxiliary pilot signal as regenerated.

13. A method for communicating with a plurality of wireless units over a network, said method comprising the steps of:
monitoring a composite signal received from at least one of the plurality of wireless units for the presence of one or more auxiliary pilot signals; and
removing the auxiliary pilot signals from the composite signal to form at least one output signal.

14. The method of claim 13 further comprising:
prior to the step of removing the auxiliary pilot signals from the composite signal, regenerating the auxiliary pilot signals from the composite signal.

15. The method of claim 14 further comprising:
prior to the step of removing the auxiliary pilot signals from the composite signal, combining the plurality of regenerated auxiliary pilot signals into an aggregate signal; and
removing the aggregate signal from the composite signal.

16. The method of claim 15 further comprising:
determining at least one channel estimation from the aggregate signal; and
decoding data from the at least one output signal based at least in part on the at least one channel estimation.

17. The method of claim 13 further comprising:
decoding data from the at least one output signal.

18. The method of claim 17 further comprising:
determining at least one channel estimation from the one or more auxiliary pilot signals, wherein the data is decoded based at least in part on the at least one channel estimation.

19. The method of claim 18 further comprising:
prior to the step of removing the auxiliary pilot signals from the composite signal, regenerating the auxiliary pilot signals from the composite signal.

20. The method of claim 19 wherein the at least one channel estimation is determined from the auxiliary pilot signals regenerated.
